(19) United States
(12) Patent Application Publication
(10) Pub. No.: US 2003/0079154 A1
(43) Pub. Date: Apr. 24, 2003

(54) Mothed and apparatus for improving software availability of cluster computer system

(76) Inventors: Kie Jin Park, Taejon (KR); Sung Soo Kim, Suwon, Kyungggi-Do (KR); Sang Hyun Kim, Taejon (KR); Jang Kyung Kim, Taejon (KR); Joong Moo Park, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/015,768

(22) Filed: Dec. 17, 2001

(30) Foreign Application Priority Data
Oct. 23, 2001 (KR) 2001-65337

(51) Int. Cl. H02H 3/05

(52) U.S. Cl. 714/1

(57) ABSTRACT

The invention relates to a method and apparatus for improving software availability of a cluster computer system via a software rejuvenation technique, in which a program is temporarily stopped at an adequate time point that a manager of a cluster computer system constituted by several servers can expect, and then restarted. In the invention, both aspects of software and hardware are considered, a proactive fault-tolerance technique is utilized via software rejuvenation and availability is improved through determination of the optimal rejuvenation period according to a software unstable rate and a hardware failure rate of the cluster system so that features of a high-available computer system can be ensured efficient in cost.

### BACKGROUND OF THE INVENTION

1. Field of the Invention

The present invention relates to a method and apparatus for improving software availability of a cluster computer system, and more particularly, to a proactive fault-tolerant method for preventing failures from occurring in the cluster computer system constituted by a number of servers. Namely, the present invention relates to a method and apparatus for improving software availability of the cluster computer system using a software rejuvenation technique. Software rejuvenation that terminates an application or a system intentionally and restarts it in a clean internal state prevents failures from occurring, while previous fault-tolerant methods recover from failures after happen. As the system manager decides to stop the operation of cluster servers, cleans the internal state of the server processes, and restarts them, software rejuvenation does not require additional costs.

2. Description of the Related Art

Due to the increasing complexity of software, studies on how to implement a highly available system using cluster technology are becoming more actively sought after. Cluster systems using commercially available personal computers connected in a loosely coupled fashion can provide high levels of availability. Moreover, highly available cluster systems become more and more popular for their cost effectiveness.

Due to the fast increase in size and complexity of software, the frequency of software-originated system failure is much higher than that of hardware-originated system failure. It is therefore almost impossible to develop error-free software.

Generally, software-aging phenomena such as memory leak and buffer overflow proceed fast in the software of cluster servers due to the loss of communications or data. After rejuvenating cluster systems by buffer flushing, memory cleaning, file system purging, and initialization of the file allocation table, the systems can restart their service from a healthy condition in which the probability of a software failure is very low.

Conventional software fault-tolerant methods such as recovery block, N-version programming, N-self checking programming and checkpointing can hardly adapt themselves to the new computing environment variation, and also due to high cost and software complexity the above-mentioned reactive methods are hardly used for the availability improvement of cluster systems.

Software implemented in servers having the client-server computing environment must run for a considerably long time period. The longer server software runs, the more inevitable it is that error data be accumulated due to request of a number of clients. Software aging due to long running increases the probability that the systems are deteriorated in performance and have transient faults. As the software used in servers begins to age, software faults such as memory loss, file sharing error, and data damage are prone to occur. However, it is very difficult to detect the failure of a cluster server caused by software aging (this kind of error is called “heisenbugs” in the fault tolerance field). If software faults increase with software aging, the possibility of a system failure becomes high.

According to rapid development of hardware technologies, software has more influence to system availability over hardware. In particular, as sophisticated large-scale software appears, development of defect-free software is substantially impossible so that the necessity about software-fault tolerance is going more important. Most software faults are transient rather than permanent, and most of those transient faults caused by software aging disappear when the system is restarted.

FIG. 1 shows a block diagram of a general cluster computer system. Referring to FIG. 1, clients and servers are connected via high-speed subscriber networks such as Asynchronous Digital Subscriber Line (ADSL), Ethernet, cable, Local Area Network (LAN), and data of the servers are managed by storage units (represented as a number of disk arrays in FIG. 1) such as hard disk via Small Computer System Interface (SCSI), optical channel interface and Transmission Control Protocol/Internet Protocol (TCP-IP).

FIG. 2 shows a state transition model of duplex cluster computer system of the prior art, in which unstableness of long-time running software is not considered.

In FIG. 3, except the probability of the failure state (P₀) and the rejuvenation state of one running server (Pᵣ_{₁}), the cluster systems are available in all other states. Therefore, the availability of the system with rejuvenation can be expressed as the following Equation 1:

Availability=1−(P₀+Pᵣ_{₁}) Equation 1,

Herein, P₀ designates a state probability that all of the servers have failures, and Pᵣ_{₁} designates a state probability that rejuvenation is executed when one server is running.

Downtime means a situation that a service cannot be provided due to an accidental failure or the software rejuvenation, and can be expressed as a function of the running time T of the cluster computer system as in the following Equation 2:

Downtime(T)=(1−Availability)*T Equation 2.

Downtime cost due to malfunction of the server satisfies the following Equation 3:

Cost(T)=(P₀*C_{f}+Pᵣ_{₁}*Cᵣ)*T Equation 3,

Herein, C_{f} designates downtime cost per unit time due to shutdown of the server, and Cᵣ designates downtime cost per unit time due to the software rejuvenation. In general, scheduled downtime cost is far less than that of unexpected downtime cost(C_{f}>Cᵣ).

It has been confirmed that the proactive fault-tolerant methods via software rejuvenation have high applicability through experiment based upon system operating parameters such as rejuvenation period, rejuvenation time, failure rate and repair rate of the servers, number of running servers, duration of running time, and type of running modes.

It has been also understood that the software-related unstable rate and the hardware-related failure rate of server due to long running are important characteristic elements in improving availability of the cluster system.

However, the foregoing software rejuvenation techniques for improving availability of the computer system of the prior art are focused to high-priced and duplexed large-scale server systems but not to cluster computer systems that are currently in the limelight with high-performance and high-availability. Therefore, there is a problem that it is difficult to establish cost-efficient high-available systems.

### SUMMARY OF THE INVENTION

Accordingly, the present invention has been devised to solve the foregoing problems of the prior art, and it is an object of the invention to provide a method and apparatus for improving software availability of a cluster computer system via a software rejuvenation technique, by which a program is temporarily stopped at an adequate time point which is expectable by a manager of a cluster computer system constituted by several servers, and then restarted. In other words, it is aimed to provide a method and apparatus for improving software high-availability of the cluster computer system, which adopts a proactive fault-tolerance technique via software rejuvenation with regard to both aspects of software and hardware.

Further, it is another object of the invention to provide a method and apparatus for improving software availability of a cluster computer system, which determines the optimal rejuvenation period according to software unstableness and hardware failure rate of the cluster system so that the high-available computer system can ensure the cost efficient features.

According to the invention to obtain the foregoing objects, high availability is obtained to disclose software rejuvenation technique in such a fashion that the availability of cluster computer system calculated from parameters such as hardware failure rate of servers constituting the cluster, unstable rate reflecting an unstable state due to long-running of software installed in the servers, consumed rejuvenation time necessary for going back to the initial system operation state having a low failure occurring probability, continuous running time of the cluster system and downtime cost per unit time can be maximized while downtime cost can be minimized.

According to an aspect of the invention, it is provided a method for improving software availability of a cluster computer system including a number of primary servers and spare servers, the method comprising the following steps of: collecting system state information about the number of primary servers to monitor unstableness of the servers; if at least one of the servers is judged unstable as a result of monitoring, judging existence of a spare server or other primary server having spare capacity; if at least one of the spare servers or the primary servers having spare capacity exists, duplexing all processes of the unstable primary server to the spare server or the other primary server having spare capacity according to a currently set operation mode; and upon completing duplexing, providing the unstable server with a system rejuvenation control signal for executing rejuvenation. Herein, system state information contains at least one of group including operational load, continuous running time, memory usage, and buffer usage of the primary server.

Preferably, the step of duplexing comprises the steps of: if the current mode is set as an active/standby mode or an active/active mode, selecting any of the sparing servers or any of the primary servers having spare capacity; and duplexing all the processes of the unstable primary server to the selected spare server or the selected primary server having spare capacity.

Preferably, the step of executing rejuvenation comprises the steps of: if the primary server subjected to rejuvenation is completed in duplexing, judging if to execute a rejuvenation command according to operational load and continuous running time of the primary server subjected to rejuvenation; if it is judged to execute the rejuvenation command as a result of the step of judging, canceling a list of the primary server subjected to rejuvenation from an available server list; upon switching the duplexed spare server to the primary server, executing rejuvenation of the primary server subjected to rejuvenation; and upon completing rejuvenation, registering the rejuvenation-completed primary server in the available server list as a spare server. Herein, the rejuvenation of the primary server subjected to rejuvenation includes file system clearing, buffer clearing, memory clearing and restart.

According to another aspect of the invention, it is provided a method of monitoring a fault of a cluster computer system of the invention, the method comprising the following steps of detecting service down due to a fault of each of primary servers; if service is down due to the fault in a primary server as a result of the detecting step, switching the primary server to a spare server and generating a fault recovery command of the primary server with the fault; a) executing transition of all functions of the primary server to the spare server according to the fault recovery command, and b) upon completing transition to the spare server, registering the spare server as a primary server and canceling the primary server with the fault from an available server list; and recovering the fault of the primary server canceled from the available server list and registering the fault-recovered server as a spare server in the available server list.

According to further another aspect of invention, it is provided an apparatus for improving software availability of a cluster computer system including a number of primary servers and spare servers, comprising: system monitoring means for collecting system state information about the number of primary servers to grasp an unstable state of each of the servers; cluster controlling means for providing a control signal for duplexing all processes of a primary server to a spare server or other primary server having spare capacity according to a currently set operation mode if the primary server is unstable as a result of system monitoring in the system monitoring means, and for providing the unstable primary server with a rejuvenation signal for system rejuvenation if the unstable primary server maintains an unstable system state for a certain time period; and duplexing means for duplexing all processes of the unstable primary server to the spare server or the other server having spare capacity according to a duplexing control signal about the set mode provided from the cluster controlling means.

Preferably, the system monitoring means comprises: a system state information collecting block for monitoring a system state of each of the primary servers to collect state information of the each server; and a rejuvenation command producing block for judging existence of an unstable primary server according to system state information collected in the system state information collecting block, and if any of the primary servers is unstable, producing a rejuvenation command signal for rejuvenation of unstable software of the unstable primary server and providing the same to the duplexing means.

Also preferably, the cluster controlling means includes registering means for canceling the unstable primary server from an available server list when the unstable primary server is duplexed to the spare server or the other primary server having spare capacity in the duplexing means, and upon completing rejuvenation of the unstable primary server according to the rejuvenation signal, re-registering the rejuvenation-completed primary server in the available server list.

Preferably, the duplexing means comprises: a server selecting block for selecting a spare server or a primary server having spare capacity according to the operation mode set to the cluster controlling means; and a duplexing block for duplexing all the processes of the unstable primary server to the primary server having spare capacity selected by the primary server selecting block when the operation mode is set as an active/active operation mode, and for duplexing all the processes of the unstable primary server to the spare server selected by the primary server selecting block when the operation mode is set as an active/standby operation mode.

According to still another aspect of the invention, it is provided an apparatus of monitoring a fault of a cluster computer system of the invention, the apparatus comprising: means for detecting service down due to a fault of each of primary servers; a fault recovery command producing means for switching a primary server to a spare server and producing a fault recovery command of the primary server with the fault if service is down due to the fault in the primary server as a result of detection; fault recovering means for a) executing transition of all functions of the primary server to the spare server according to the fault recovery command, and b) upon completing transition to the spare server, registering the spare server as a primary server and canceling the primary server with the fault from an available server list, and c) recovering the fault of the primary server canceled from the available server list and registering the fault-recovered server as a spare server in the available server list.

According to further another aspect of the invention, it is provided a record medium readable by a digital processing apparatus and containing programs of command languages which can be executed by the digital processing apparatus for execution of a method for improving software availability of a cluster computer system including a number of primary servers and spare servers, the programs in the record medium can be executed in the following steps of: collecting system state information about the number of primary servers to monitor unstableness of the servers; if at least one of the servers is judged unstable as a result of monitoring, judging existence of a spare server or other primary server having spare capacity; if at least one of the spare servers or the primary servers having spare capacity exists, duplexing all processes of the unstable primary server to the spare server or the other primary server having spare capacity according to a currently set operation mode; and upon completing duplexing, providing the unstable server with a system rejuvenation control signal for executing rejuvenation.

Also, according to other aspect of the invention, it is provided a record medium readable by a digital processing apparatus and containing programs of command languages which can be executed by the digital processing apparatus for execution of a method for monitoring a fault of a cluster computer system including a number of primary servers and spare servers, the method is executed in the following steps of: detecting service down due to a fault of each of primary servers; if service is down due to the fault in a primary server as a result of the detecting step, switching the primary server to a spare server and generating a fault recovery command of the primary server with the fault; a) executing transition of all functions of the primary server to the spare server according to the fault recovery command, and b) upon completing transition to the spare server, registering the spare server as a primary server and canceling the primary server with the fault from an available server list; and recovering the fault of the primary server canceled from the available server list and registering the fault-recovered server as a spare server in the available server list.

### BRIEF DESCRIPTION OF THE DRAWINGS

FIG. 1 shows a block diagram of a general cluster computer system;

FIG. 2 shows a state transition model of a cluster computer system of the prior art;

FIG. 3 shows a state transition model of a cluster computer system with regard to software rejuvenation of the invention;

FIG. 4 illustrates a software rejuvenation technique applied to a duplexed cluster system of the invention;

FIG. 5 shows a cluster computer system configuration, which includes an apparatus for improving software availability of the invention;

FIG. 6 shows a detailed configuration of a clustering module shown in FIG. 5;

FIG. 7 shows a detailed configuration of a software rejuvenation module shown in FIG. 5;

FIG. 8 shows a detailed configuration of a fault tolerance module shown in FIG. 5;

FIG. 9 shows a connection configuration of the apparatus for improving software availability of the cluster computer system of the invention shown in FIGS. 6 to 8;

FIG. 10 is a flow chart for showing a method of recovering an unstable state of a server or an unstable state of software in a method for improving software availability in a cluster computer system of the invention; and

FIG. 11 shows a flow chart of a method for recovering a fault in a server (when service is down due to a hardware fault) in a method for improving software availability in a cluster computer system of the invention.

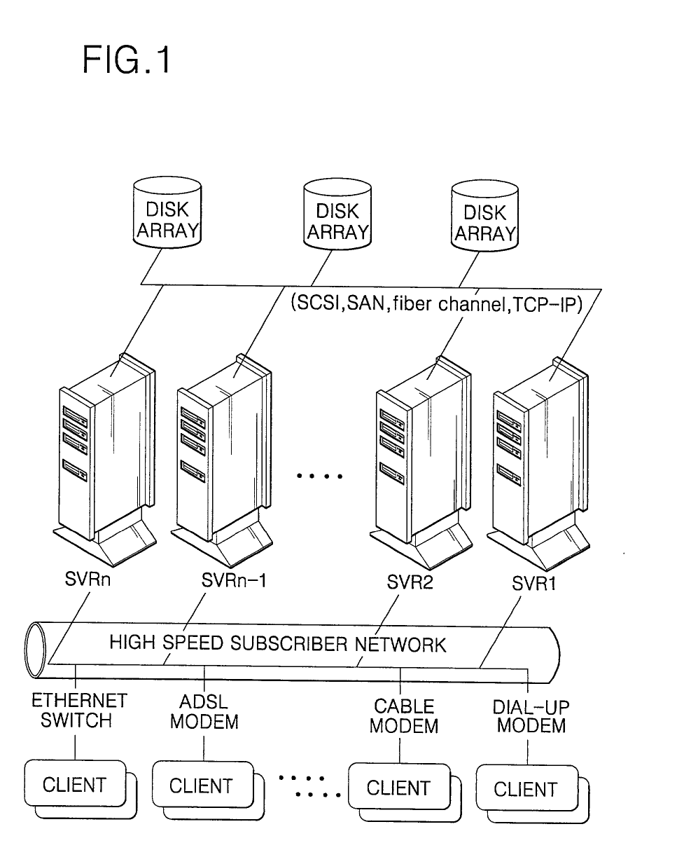

### DETAILED DESCRIPTION OF THE PREFERRED EMBODIMENT

The following detailed description will first present a brief discussion about a state transition model of a cluster computer system with regard to software rejuvenation, and then will disclose a method and apparatus for improving software availability of a cluster computer system according to a preferred embodiment of the invention.

FIG. 3 shows a state transition model of a cluster computer system with regard to software rejuvenation of the invention.

As shown in FIG. 3, servers operating in a normal state have state parameters such as n, n−1, . . . , 1 and 0 which are respectively the number of servers in operation, whereas those servers unstable due to long-running are expressed as uₙ, uₙ₋₁, . . . u₂ and u₁.

In the unstable state, rejuvenation will be executed with a rejuvenation rate of λᵣ, or a failure will take place with a failure rate of i*λ, herein i is the number of servers in normal operation.

Further, the rate of change from the normal state to the unstable state is indicated as λ_{f}, which reflects unstableness of the system due to long-running of software. In FIG. 3, rₙ, rₙ₋₁, . . . and r₁ in a rejuvenation area 200 express rejuvenation states representing the situations in which the system is intentionally stopped and then restarted.

In order to obtain mathematical solutions in an operational state model of the cluster computer system, assume as follows: In the cluster computer system constituted by n number of servers, each server has the same failure rate λ as well as the same repair rate μ for repairing failed servers.

In executing software rejuvenation in the cluster computer system, the rejuvenation rate λᵣ for forcibly stopping the server is identical in the whole operational states, whereas a rejuvenation operation rate μᵣ is not concerned with the number of servers. In occurrence of fault in the cluster system, a switchover time to another server is extremely short and thus may be disregarded, and the rejuvenation is executed without stopping the current service except for a simplex system. Finally, the length of time staying in the whole states of FIG. 3 follows an exponential distribution.

The state transition model of the cluster computer system of FIG. 3 forms an irreducible recurrent non-null Markov chain under the foregoing assumption so that probabilities in a balance state can be obtained in a relatively easy manner, in which steady-state probabilities satisfy the following Equations 4, 5, 6 and 7:

$$\begin{matrix}{P}_{{u}_{n - i}} = \frac{{λ}_{f}}{{λ}_{r} + ( n - i ) λ} {P}_{n - i} , i = 0 , 1 , … , n - 1 , & Equation 4 \\ {P}_{{r}_{n - i}} = \frac{{λ}_{r}}{{μ}_{r}} \frac{{λ}_{f}}{{λ}_{r} + ( n - i ) λ} {P}_{n - i} , i = 0 , 1 , … , n - 1 , & Equation 5 \\ {P}_{n - i} = {( \frac{{λ}_{f}}{μ} )}^{i} {\prod }_{k = 0}^{i - 1} ( 1 - \frac{{λ}_{f}}{{λ}_{r} + ( n - k ) λ} ) * {P}_{n} , \\ i = 1 , 2 , … , n , a n d & Equation 6 \\ {P}_{n} = {[ \begin{matrix}1 + {\sum }_{i = 1}^{n} ( {( \frac{{λ}_{f}}{μ} )}^{i} {\prod }_{k = 0}^{i - 1} ( 1 - \frac{{λ}_{f}}{{λ}_{r} + ( n - k ) λ} ) ) \\ ( 1 + \frac{{λ}_{r}}{{μ}_{r}} ) + ( {\sum }_{i = 1}^{n - 1} \frac{{λ}_{f}}{{λ}_{r} + ( n - i ) λ} {( \frac{{λ}_{f}}{μ} )}^{i} \\ {\prod }_{k = 0}^{i - 1} ( 1 - \frac{{λ}_{f}}{{λ}_{r} + ( n - k ) λ} ) + \frac{{λ}_{f}}{{λ}_{r} + n λ} )\end{matrix} ]}^{- 1} . & Equation 7\end{matrix}$$

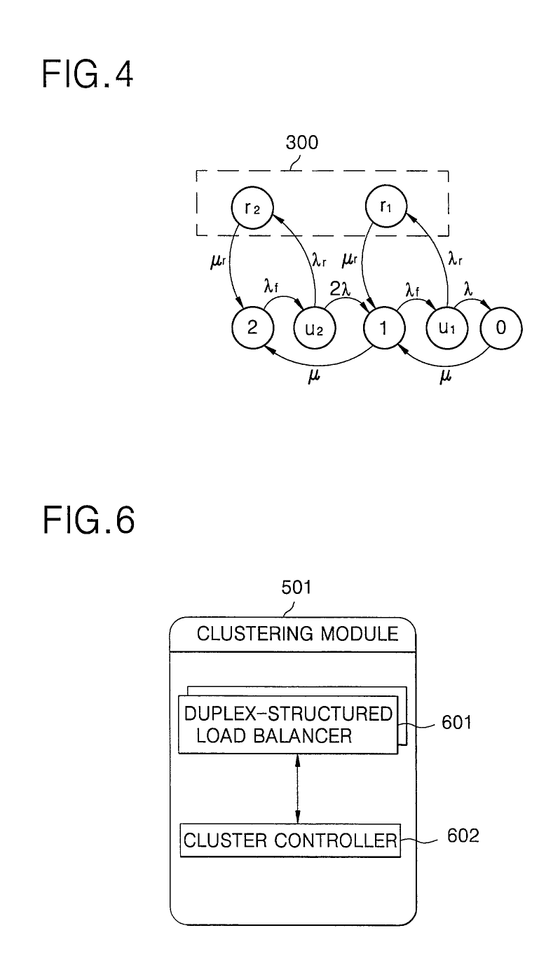

FIG. 4 shows an example of a software rejuvenation technique in a duplexed cluster system applied according to the invention.

Two servers u₂ operating in the unstable state, as shown in FIG. 4, have a hardware failure with a failure rate of 2λ, herein λ can be calculated from the Mean Time To Failure (MTTF) of the servers. In the failure state that both of the two servers are down, the failure is repaired in a rate of μ, which can be obtained from the Mean Time To Repair (MTTR) that measures a failure repairing ability. In the unstable state that the servers are degraded in performance due to software aging caused by long-running, the system intentionally stops to the rejuvenation state 300 or r₂ and r₁ or proceeds to the failure state.

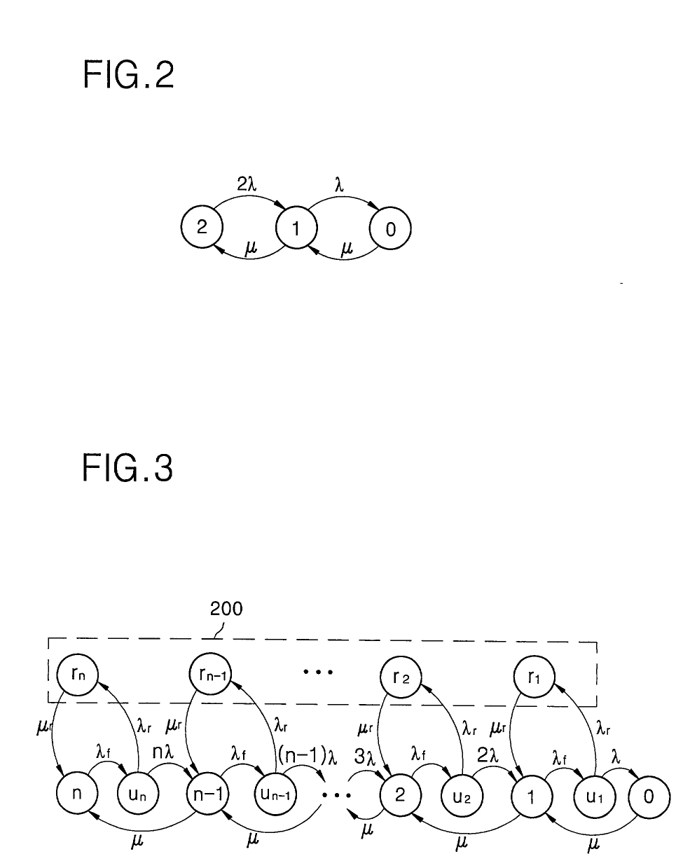

After all, the prior art shown in FIG. 2 represents the transition model without regard to unstableness of aged software, in which expression is not made about the unstable state or the software rejuvenation state. In other words, availability, downtime and downtime cost are defined from the probabilities, which are derived from the state transition model of the cluster computer system in FIG. 3 according to the foregoing Equations 1, 2 and 3.

Hereinafter, detailed description will be made about the method and apparatus for improving software availability of the cluster computer system according to the preferred embodiment of the invention in reference to the accompanying drawings.

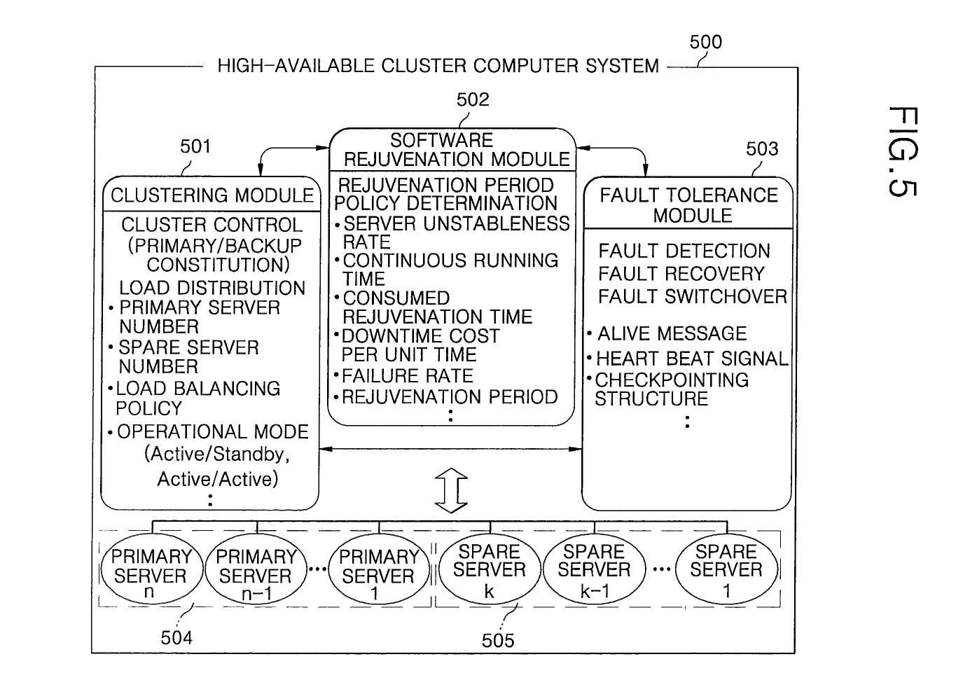

FIG. 5 shows a configuration of a cluster computer system including an apparatus for improving software availability of the invention, which represents the structure of a high-available cluster computer system subjected to application of the software rejuvenation technique comprising a clustering module 501, a software rejuvenation module 502 and a fault tolerance module 503.

The clustering module 501 provides a function for connecting several computers to establish the high-available cluster system with no theoretical limitations in the number of servers, which can be connected. The operational mode of the cluster computer system is classified into active/standby and active/active modes: in the former, spare servers 505 are not included in service in practice, and in the latter, all servers participate in service while mutually performing the role of the spare servers 505.

Further, the clustering module 501 performs a load-balancing function for adjusting an operational load of the each server constituting the cluster computer system as well as transmits/receives data necessary for the software rejuvenation module 502 and for rejuvenation.

The software rejuvenation module 502 grasps the software-related unstableness of the servers in the cluster computer system based upon inspection results according to system operation parameters, and then produces a command for forcibly stopping the unstable servers. Such a rejuvenation command recovers the unstable servers to the initial operational state thereof having a low probability of fault occurrence via assistance of the fault tolerance module 503 and the clustering module 501. In this case, the standard, method and procedure of the rejuvenation can be adequately selected according to applications of the cluster computer system.

Also, the fault tolerance module 503 functions to detect faults of the cluster computer system servers as well as switch and repair those servers in fault. Various fault detection policies such as Heart Beat, Watch Dog and so on can be used in order to perform a fault detection function, in which the operational state of the primary server 504 where the fault-tolerance technique such as checkpointing is utilized to the standby spare server 505 or other server with allowance.

Further, FIG. 5 shows an example of the cluster computer system constituted by n+k number of servers including n number of primary servers 504 and k number of spare servers 505. In general, all the processes executed in the servers subjected to rejuvenation are stopped, and the servers restart in a state with a low probability of fault occurrence after completing the rejuvenation. The clustering module 501 does not distribute the operational load to the servers subjected to rejuvenation before the rejuvenation command is executed, and is informed of server information in a healthy state with a low probability of fault occurrence that rejuvenation is executed so as to be re-allocated with the operational load. Therefore, the rejuvenation is executed in respect to the each server rather than the processes executed in the rejuvenation-subjected servers, which can remarkably reduce overhead cost such as complexity of data and data structure design which take place in executing rejuvenation in respect to the processes.

Referring to the (n, k) cluster computer system as in FIG. 5, all the processes of the server for the rejuvenation command are switched over to a specific standby server before rejuvenation is executed so that downtime cost may not occur due to availability deterioration.

Cost effect is elevated compared to performance if the high-available cluster system is constituted without the spare servers. If the spare servers are provided, trade-off takes place in which performance is lowered but availability about service increases.

FIG. 6 shows a detailed configuration and operation of the clustering module of the high-available cluster computer system as shown in FIG. 5.

The clustering module 501 is constituted by a duplex-structured load balancer 601 and a cluster controller 602.

The duplex-structured load balancer 601 in the clustering module 501 functions to equally distribute load to each of the cluster servers as well as performs the command from the software rejuvenation module 502 by itself

After considering the continuous running time and the current running load of a specific server, a server subjected to rejuvenation is selected. The selected server is excluded from an available server list of the load balancer 601. Then, the rejuvenation command is ordered when the optimal rejuvenation condition is established according to the applications.

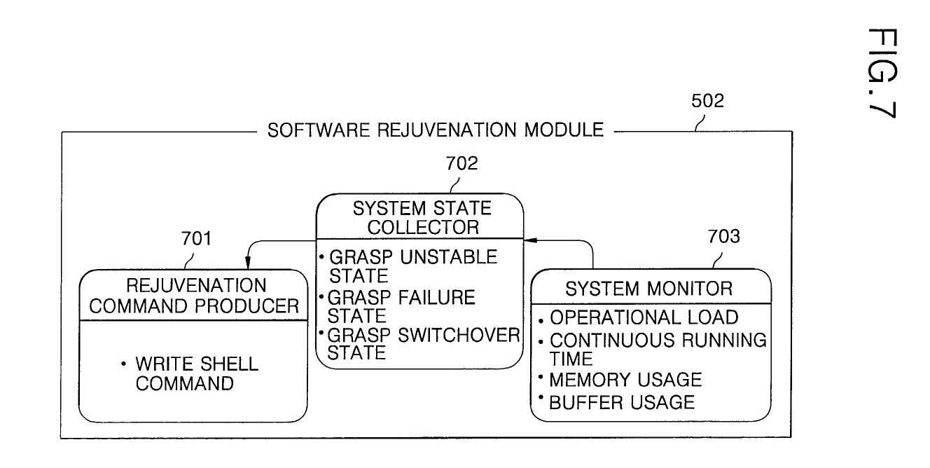

Again, FIG. 7 shows a detailed configuration of the software rejuvenation module 502 of FIG. 5. Referring to FIG. 7, the software rejuvenation module 502 is constituted by a rejuvenation command producer 701, a system state collector 702 and a system monitor 703.

The rejuvenation command producer 701 can produce the software rejuvenation command after considering the operational states such as operational load and continuous running time of the cluster computer system. Meanwhile, the software rejuvenation can be executed static regardless of the operation state of the cluster computer system, in particular, in a periodic fashion. The rejuvenation is executed using a background demon process, in which future periodic rejuvenation time and condition can be reserved using a command such as cron in the UNIX environment in executing the static software rejuvenation.

The system state collector 702 manages information about the present state of the cluster server, for example, unstable state, failure state and operation transition state of the server. Such state information is inputted into the rejuvenation command producer 701 together with information about the processes in the cluster server such as operational load, continuous running time and memory usage grasped in the system monitor 703 to be used for establishing a rejuvenation policy.

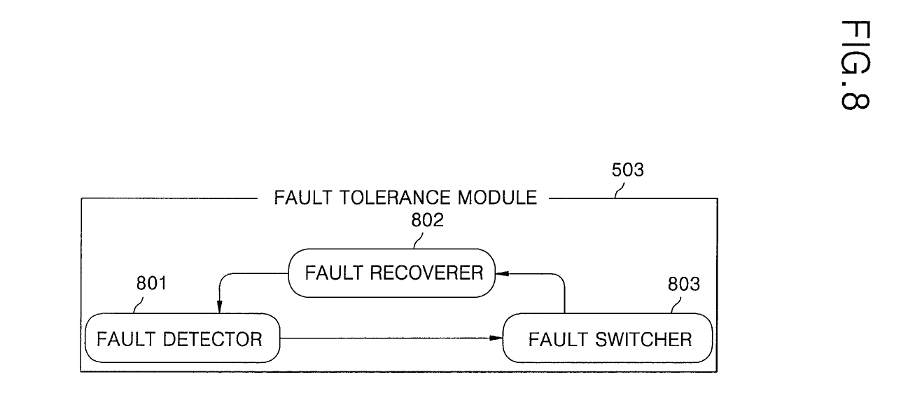

Meanwhile, the fault tolerance module 503 shown in FIG. 5 will be described in detail in reference to FIG. 8. FIG. 8 shows a detailed configuration of the fault tolerance module shown in FIG. 5, which comprises a fault detector 801, a fault recoverer 802 and a fault switcher 803.

The fault detector 801 detects service down due to failure of a server.

Upon detecting a fault of the server, a detection signal is sent to the fault switcher 803, which separates/switches the server that is fault-detected in the fault detector 801 from the cluster computer system.

When the fault-detected server is switched from the cluster computer system by the fault switcher 803, the fault recoverer 802 executes a function transition from the primary server to the spare server. When the server is stopped intentionally, the server under the rejuvenation command receives the command for duplexing of the fault tolerance module 503 to transfer all process-related information of the rejuvenation-subjected server to the spare server so that the processes of the primary server can be completely duplexed.

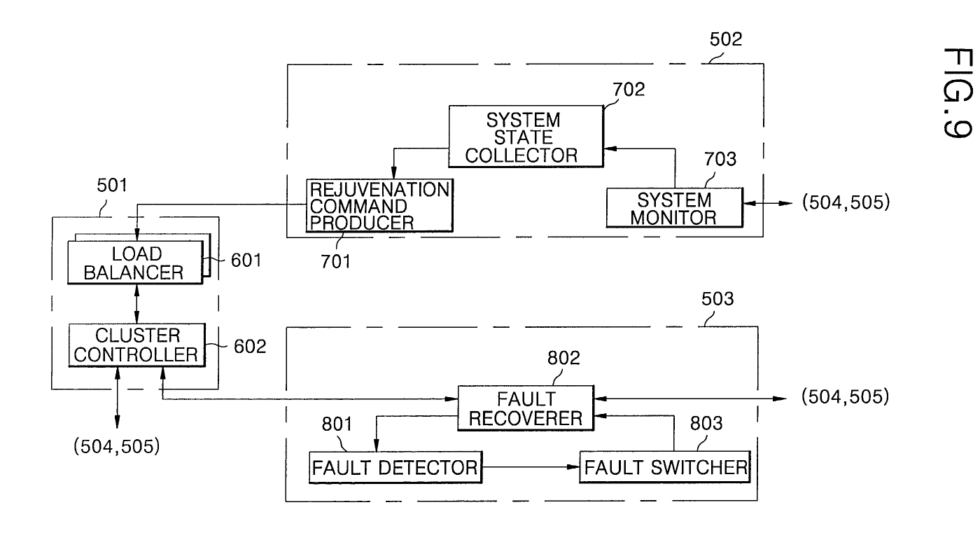

The operation of the apparatus for improving software availability of the cluster computer system configured as above according to the invention will be described in detail in reference to FIG. 9.

FIG. 9 shows a connection configuration of the apparatus for improving software availability of the cluster computer system of the invention, in which the inner structure thereof is the same as those of FIGS. 6 to 8 and thus omitted in description thereof. Referring to FIG. 9, description will be made discriminately about rejuvenation where the server is unstable and where the server has a fault.

First, considering the server in the unstable state, the system monitor 703 of the software rejuvenation module 502 monitors operational loads, continuous running-times, memory usages, buffer usages and the like of the primary servers 504, and provides monitored information to the system state collector 702.

The system state collector 702 provides the rejuvenation command producer 701 with software-unstable states, failure states, operation transition states and the like of the primary servers 504 which are grasped by using monitored information of the servers from the system monitor 703.

The rejuvenation command producer 701 judges if any of the primary servers 504 is unstable according to state information of the primary servers 504 provided from the system state collector 702. If at least one of the primary servers 504 is unstable, the rejuvenation command producer 701 produces the rejuvenation command for rejuvenation of the corresponding one or recovery of unstable software, and informs the command to the load balancer 601 in the clustering module 501. In other words, the load balancer 601 is informed of the unstable primary server subjected to rejuvenation.

The load balancer 601 provides the cluster controller 602 with a rejuvenation control signal for rejuvenation of the corresponding server.

Therefore, the cluster controller 602 judges existence of the spare servers 505 or the primary servers 504 having spare capacity. If at least one of the spare servers or the primary servers having spare capacity exists, the cluster controller 602 judges a currently set mode, and provides the fault recoverer 802 of the fault tolerance module 503 with the rejuvenation control signal for rejuvenation of the unstable primary server according to the currently set mode.

The fault recoverer 802 in the fault tolerance module 503 duplexes the processes of the unstable main server to the spare server or the primary server having spare capacity in response to the control signal from the cluster controller 602. In this case, the mode is set by a manager, and if the currently set mode is an active/standby mode, the fault recoverer 802 selects an arbitrary spare server to duplex all the processes in the unstable primary server to the selected spare server.

Meanwhile, when the current mode is set as an active/active mode, the fault recoverer 802 duplexes all the processes of the unstable primary server to an arbitrary server having spare capacity. Even after the duplexing is completed like this, the system monitor 703 of the software rejuvenation module 502 monitors operational load, continuous running time, memory usage, buffer usage and the like of the primary server subjected to rejuvenation or the unstable primary server. Therefore, the load balancer 601 of the clustering module 501 considers information of the primary server subjected to rejuvenation such as operational load and continuous operational time provided from the software rejuvenation module 502 so as to judge if the rejuvenation command will be executed.

When the primary server subjected to rejuvenation maintains the unstable system state, the cluster controller 602 excludes the primary server subjected to rejuvenation from an available server list of the load balancer 601 and switches the rejuvenation-subjected primary server and the spare server or the server having spare capacity to the primary server.

Then, the cluster controller 602 transmits the rejuvenation command to the primary server subjected to rejuvenation, and the corresponding primary server executes software rejuvenation. In this case, the software rejuvenation is executed via file system clearing, buffer clearing, memory clearing, restart and the like.

Such a primary server completed with rejuvenation provides rejuvenation-complete information to the cluster controller 602, which receives and registers such information in the available server list of the load balancer to utilize the rejuvenation-completed server as a spare server later.

Then, it will be described about the fault recovering operation in any of the primary servers 504 when service is stopped due to the fault occurred therein.

First, the operation of detecting and recovering fault of the primary server simultaneously proceeds regardless of the software rejuvenation in the corresponding server when the foregoing server is unstable.

The fault detector 801 in the fault tolerance module 503 shown in FIG. 9 detects fault, if any, of the number of primary servers 504.

As a result of detection, if it is detected that any of primary servers 504 has the fault, the fault detector 801 provides a detection signal to the fault switcher 803.

The fault switcher 803 switches the primary server, which is fault-detected in the fault detector 801 to a spare server, and as a result, provides the fault recoverer 802 with a recovery command signal of the primary server having the signal and fault occurred therein. In this case, the switched spare server performs the role of the primary server.

Therefore, the fault recoverer 802 recovers the fault of the primary server having the fault occurred therein.

When fault recovery is completed, the corresponding server, which is cleared of the fault, is registered in the available server list of the load balancer 601 via the cluster controller 602.

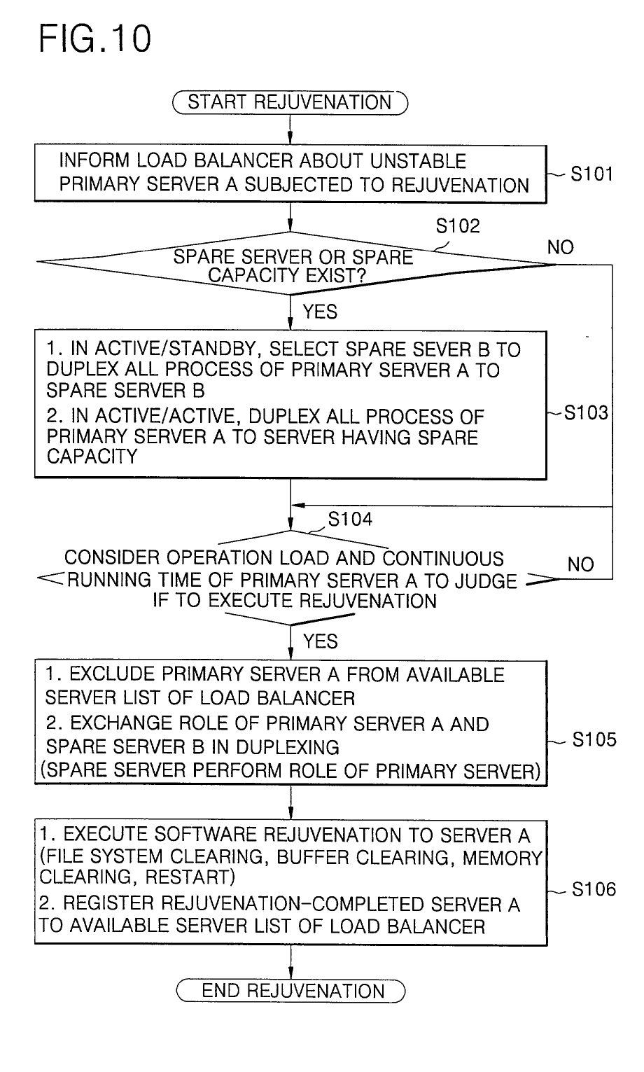

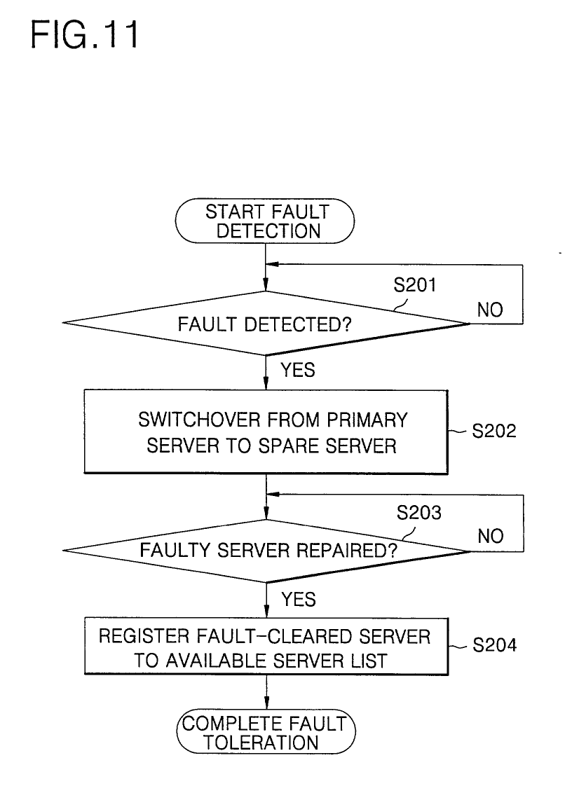

In the method for improving software availability of the cluster computer system of the invention corresponding to the operation of the apparatus for improving software availability of the cluster computer system of the invention described hereinbefore, description will be made respectively about a method for recovery when the server is unstable and a method for recovery when the server has a fault (i.e., service is down due to the hardware fault) in reference to FIGS. 10 and 11.

FIG. 10 is a flow chart for showing a method of recovering an unstable state of a server or an unstable state of software in a method for improving software availability in a cluster computer system of the invention.

First, monitoring is executed about operation load, continuous running time, memory usage, buffer usage and the like of the primary servers, and monitored information of the servers are used to grasp a software unstable state, a failure state, an operation transition state and the like of the primary servers.

State information grasped in such a fashion is used to judge if any of the primary servers is unstable. If at least one of the primary servers is unstable, a rejuvenation command is produced for recovery of unstable software of the corresponding primary server or rejuvenation of the unstable server, and informed to the load balancer in the clustering module S101. In other words, the primary server subjected to rejuvenation in the unstable state is informed to the load balancer 601.

Then, it is judged about existence of any of the spare servers or the primary servers having spare capacity for rejuvenation of the unstable primary server S102.

If at least one of the spare servers or the primary servers having spare capacity exists as a result of judgment, a currently set mode is judged, and all processes in the unstable primary server is duplexed to the spare server or the primary server having spare capacity according to the currently set mode.

In this case, the mode is set by the manager, and if the currently set mode is an active/standby mode, an arbitrary spare server is selected to duplex all the processes in the unstable primary server to the selected spare server.

Meanwhile, when the current mode is set as an active/active mode, all the processes of the unstable primary server are duplexed to an arbitrary server having spare capacity in S103.

Even in such a state that a duplexing is completed, monitoring is executed about operation load, continuous running time, memory usage, buffer usage and the like of the unstable server or the primary server subjected to rejuvenation, and consideration is made about monitored information of the primary server subjected to rejuvenation such as operation load, continuous operation time and the like to continuously judge if the rejuvenation command will be executed in S104.

If the primary server subjected to rejuvenation continues to maintain unstable, the primary server subjected to rejuvenation is excluded from the available server list of the load balancer in the clustering module, and the spare server or the server having spare capacity is switched to the primary server in S105.

Then, the rejuvenation command is transmitted to the primary server subjected to rejuvenation so that the primary server executes rejuvenation. In this case, software rejuvenation is executed via file system clearing, buffer clearing, memory clearing, restart and the like.

The primary server completed with rejuvenation like this provides available server list registration information to the load balancer via the cluster controller, and accordingly the load balancer registers the corresponding server to the available server list in S106.

FIG. 11 shows a flow chart about a method for recovering a fault in a server (when service is down due to a hardware fault) in a method for improving software availability in a cluster computer system of the invention.

First, it is detected if the primary servers have a fault to judge if any of the primary servers has a fault through the fault detector in S201.

If it is detected that at least one of the primary servers has the fault as a result of judgment, the fault-detected primary server is switched to the spare server so that the spare server performs the role of the primary server in S202.

Then, while the spare server performs the operation of the primary server, the fault of the primary server is recovered. In sequence, it is judged if all the faults are recovered in the primary server S203.

When the corresponding server is completed with fault recovery, the corresponding server, which is cleared of the fault, is registered in the available server list of the load balancer in the clustering module to complete the fault tolerance operation in S204.

According to the method and apparatus for improving software availability of the cluster computer system of the invention as described hereinbefore, proactive fault-tolerance is enabled to prevent a fault before occurring compared to a conventional fault-tolerance method which reacts after the fault occurs in the system.

The invention as above is one of the fundamental technologies essential to the future internet-based business era as well as a basic element for providing a high-reliable data service in the Internet environment. The software rejuvenation technique can prevent the failure of software installed in a related system to reduce currently increasing maintenance cost thereby enhancing competitiveness of a product.

Further, since a technological industry related to the large-scale transaction service can be a core of all high-quality computers, the rejuvenation technique of the invention can be a cornerstone of fundamental technologies for improving availability in various computer system designing fields.

In particular, since software used in the multimedia mobile computing is more rapid in aging compared to general software due to communication, down, data washout and the like, the proactive fault-tolerance method via software rejuvenation can be highly probable to be used in the large-scale multimedia mobile computing system.

What is claimed is:

1. A method for improving software availability of a cluster computer system including a number of primary servers and spare servers, said method comprising the following steps of:
collecting system state information about the number of primary servers to monitor unstableness of the servers;
if at least one of the servers is judged unstable as a result of monitoring, judging existence of a spare server or other primary server having spare capacity;
if at least one of the spare servers or the primary servers having spare capacity exists, duplexing all processes of the unstable primary server to the spare server or the other primary server having spare capacity according to a currently set operation mode; and
upon completing duplexing, providing the unstable server with a system rejuvenation control signal for executing rejuvenation.

2. A method for improving software availability of a cluster computer system according to claim 1, wherein said system state information contains at least one of group including operational load, continuous running time, memory usage, buffer usage of the primary server.

3. A method for improving software availability of a cluster computer system according to claim 1, wherein said set operation mode in said step of duplexing includes:
an active/standby mode in which a spare server exists without participating service in practice for being used in duplexing; and
an active/active mode in which all of the servers constituting the cluster participate in service while mutually performing the role of the spare servers.

4. A method for improving software availability of a cluster computer system according to claim 1, wherein said step of duplexing comprises the steps of:
if the current mode is set as the active/standby mode, selecting any of the sparing servers; and
duplexing all the processes of the unstable primary server to the selected spare server.

5. A method for improving software availability of a cluster computer system according to claim 1, wherein said step of duplexing comprises the steps of:
if the current mode is set as the active/active mode, selecting any of the primary servers having spare capacity; and
duplexing all the processes of the unstable primary server to the selected primary server having spare capacity.

6. A method for improving software availability of a cluster computer system according to claim 1, wherein said step of executing rejuvenation comprises the steps of:
if the primary server subjected to rejuvenation is completed in duplexing, judging if to execute a rejuvenation command according to operational load and continuous running time of the primary server subjected to rejuvenation;
if it is judged to execute the rejuvenation command as a result of said step of judging, canceling a list of the primary server subjected to rejuvenation from an available server list;
upon switching the duplexed spare server to the primary server, executing rejuvenation of the primary server subjected to rejuvenation; and
upon completing rejuvenation, registering the rejuvenation-completed primary server in the available server list as a spare server.

7. A method for improving software availability of a cluster computer system according to claim 6, wherein said rejuvenation of the primary server subjected to rejuvenation includes file system clearing, buffer clearing, memory clearing and restart.

8. An apparatus for improving software availability of a cluster computer system including a number of primary servers and spare servers, said apparatus comprising:
system monitoring means for collecting system state information about the number of primary servers to grasp an unstable state of each of the servers;
cluster controlling means for providing a control signal for duplexing all processes of a primary server to a spare server or other primary server having spare capacity according to a currently set operation mode if the primary server is unstable as a result of system monitoring in said system monitoring means, and for providing the unstable primary server with a rejuvenation signal for system rejuvenation if the unstable primary server maintains an unstable system state for a certain time period; and
duplexing means for duplexing all processes of the unstable primary server to the spare server or the other server having spare capacity according to a duplexing control signal about the set mode provided from said cluster controlling means.

9. An apparatus for improving software availability of a cluster computer system according to claim 8, wherein said system monitoring means comprises:
a system state information collecting block for monitoring a system state of each of the primary servers to collect state information of the each server; and
a rejuvenation command producing block for judging existence of an unstable primary server according to system state information collected in said system state information collecting block, and if any of the primary servers is unstable, producing a rejuvenation command signal for rejuvenation of unstable software of the unstable primary server and providing the same to said duplexing means.

10. An apparatus for improving software availability of a cluster computer system according to claim 8, wherein said system state information contains at least one information of group including operation load, continuous running time, memory usage, buffer usage of the servers.

11. An apparatus for improving software availability of a cluster computer system according to claim 8, wherein said cluster controlling means includes registering means for canceling the unstable primary server from an available server list when the unstable primary server is duplexed to the spare server or the other primary server having spare capacity in said duplexing means, and upon completing rejuvenation of the unstable primary server according to the rejuvenation signal, re-registering the rejuvenation-completed primary server in the available server list.

12. An apparatus for improving software availability of a cluster computer system according to claim 8, wherein the operation mode set in said cluster controlling means includes an active/standby mode having a spare server existing without practically participating service for being used in duplexing; and
an active/active mode in which all the servers constituting the cluster participate in server while mutually performing the role of the spare servers.

13. An apparatus for improving software availability of a cluster computer system according to claim 8, wherein said duplexing means comprises:
a server selecting block for selecting a spare server or a primary server having spare capacity according to the operation mode set to said cluster controlling means; and
a duplexing block for duplexing all the processes of the unstable primary server to the primary server having spare capacity selected by said primary server selecting block when the operation mode is set as an active/active operation mode, and for duplexing all the processes of the unstable primary server to the spare server selected by said primary server selecting block when the operation mode is set as an active/standby operation mode.

14. A record medium readable by a digital processing apparatus and containing programs of command languages which can be executed by the digital processing apparatus for execution of a method for improving software availability of a cluster computer system including a number of primary servers and spare servers, said programs in the record medium can be executed in the following steps of:
collecting system state information about the number of primary servers to monitor unstableness of the servers;
if at least one of the servers is judged unstable as a result of monitoring, judging existence of a spare server or other primary server having spare capacity;
if at least one of the spare servers or the primary servers having spare capacity exists, duplexing all processes of the unstable primary server to the spare server or the other primary server having spare capacity according to a currently set operation mode; and
upon completing duplexing, providing the unstable server with a system rejuvenation control signal for executing rejuvenation.
